(19) United States
(12) Patent Application Publication
(10) Pub. No.: US 2022/0212921 A1
(43) Pub. Date: Jul. 7, 2022

(54) METHOD OF OXIDATION IN A MOLTEN SALT BATH

(71) Applicants: INSTITUT POLYTECHNIQUE DE GRENOBLE, Grenoble (FR); CENTRE NATIONAL DE LA RECHERCHE SCIENTIFIQUE, Paris Cedex 16 (FR); UNIVERSITE GRENOBLE ALPES, Saint Martin d'Hères (FR); UNIVERSITE SAVOIE MONT BLANC, Chambery (FR)

(72) Inventors: Farouk TEDJAR, Grenoble (FR); Eric CHAINET, Froges (FR); Jacques FOULETIER, Brie et Angonnes (FR); Maguy NAHRA, Grenoble (FR)

(21) Appl. No.: 17/611,457

(22) PCT Filed: May 14, 2020
(86) PCT No.: PCT/EP2020/063512

§ 371 Date: Nov. 15, 2021

(30) Foreign Application Priority Data
May 17, 2019 (FR) 1905204

(51) Int. Cl. C01B 3/06; C10L 9/08; C10L 5/44; C10L 5/48

(52) U.S. Cl. CPC C01B 3/061; C10L 9/083; C10L 5/447; C10L 2290/06; C10L 2200/0461; C10L 2290/02; C10L 5/48

(57) ABSTRACT

A method for reusing waste including organic components in a bath of molten salt including providing to a reactor, at least one salt or a mixture of salts including at least one alkali metal hydroxide, providing the waste to the reactor, heating the at least one salt or mixture of salts in the reactor at a temperature above the melting point of the salt. Thus, the provided salt melts to form a liquid reaction medium, and induces an at least partial oxidation of the organic components. At least one compound resulting from this oxidation is recovered. At least one alkali metal hydroxide includes water of crystallisation, acting as oxidising agent for the organic compounds in the reaction medium, in such a way as to participate in the production of dihydrogen, the latter being recovered for the reuse thereof.

### TECHNICAL FIELD

The invention relates to the field of reusing waste comprising organic components, and even organic and metal components. It has for particularly advantageous application the reuse of automobile shredder residues (ASR).

### PRIOR ART

Plastics represent an increasing and substantial part of waste, yet the recycling or reuse thereof remains low.

Sorting facilities have been set up for common waste in order to facilitate the reuse thereof. These sorting modes do not however apply to waste that contains organic components, in particular waste resulting from the automobile and more particularly the shredded residue and/or in a mixture resulting from end-of-life vehicles.

For example, automobile shredder residues are difficult to reuse because they are heterogenous and can moreover contain residues of fluids that are hazardous for the environment, such as, but not limited to residues of brake fluid, antifreeze, motor oil. Furthermore, these automobile shredder residues can contain explosive substances, for example coming from the ejection devices of airbags. About 90% of automobile shredded residue is sent to a landfill or treated in incineration plants. Via these methods, the organic components of these residues, even the organic and metal components, are only very little, or even not at all, reused.

Even so, methods exist that allow for the reuse of waste comprising organic components, and even organic and metal components, such as physical separation methods, “high temperature” methods and hydrometallurgical methods.

Physical separation methods of waste in a mixture, for example via flotation, allow for a separation of the organic components and of the metal components of the waste. The recovery rate is however relatively low and requires the use of a large quantity of water which has to be treated afterwards as an effluent.

“High temperature” methods, such as via combustion, for example via incineration, emit large quantities of carbon dioxide, as well as toxic gases such as dioxin or halogenhydric acids. These methods further require high temperatures of about 1200° C., in order to produce fumes with temperatures comprised between 850° C. and 1100° C., and are therefore expensive from an energy standpoint.

Regarding the hydrometallurgical methods, they require a substantial quantity of acid or base solutions, or cyanide, thus producing a substantial volume of effluents to be treated downstream of the implementation thereof. Furthermore, these methods only concern the reuse of metal components.

The aforementioned methods therefore show limits. In particular, none of them allow for a reuse of waste comprising organic components, and even organic and metal components, by limiting their impact thereof on the environment.

Among the existing solutions, oxidation in a bath of molten salts is a method used for example for the treating of hazardous waste and waste such as used tyres where the direct incineration and the treatment of the effluents is difficult. This method is based on the use of a salt or of a mixture of salts comprising carbonates or a mixture of these compounds with sodium hydroxide. Said salt or mixture of salts is heated beyond its melting temperature to form a reaction medium and to induce an oxidation of the organic components of said waste.

Molten salts have a wide range of electrochemical stability allowing for the oxidation reactions of the organic components. Their high ionic conductivity induces a high exchange kinetics in the reaction medium. Furthermore, they have no substantial dangerousness at the environmental level.

It is in particular known from document Flandinet et al. «Metals recovering from waste printed circuit boards (WPCBs) using molten salts», Journal of Hazardous Materials, 213-214, 2012, 485-490, a method for treating waste resulting from electronics that uses a molten salt comprising a eutectic mixture of sodium hydroxide and of potassium hydroxide. Said eutectic mixture has a melting temperature of 170° C. allowing for the oxidation of the organic components of said waste at low temperature, in particular from 250° C. Thus, the energy cost and consequently the impact of the method on the environment are reduced.

In this context, the present invention proposes an alternative method of oxidation in a bath of salts that makes it possible to overcome at least one of the aforementioned disadvantages.

More particularly, the method according to the invention aims to allow for a reuse of waste comprising organic components, and even organic and metal components, with a reduced energy cost. Advantageously, the method according to the invention also aims to limit the discharge of harmful compounds during the treatment of said waste.

The other objects, features and advantages of the present invention shall appear when examining the following description and the accompanying drawings. It is understood that other advantages can be incorporated.

### SUMMARY

To achieve this objective, according to an embodiment the present invention provides a method for reusing waste comprising organic components in a bath of molten salt(s) comprising the following steps:
Providing to a reactor, at least one salt or a mixture of salts of which at least one salt, preferably each salt, comprises at least one alkali metal hydroxide or a mixture of such hydroxides;
Providing said waste to the reactor;
Heating the reactor at a temperature above the melting point of said salt or mixture of salts to melt said salt or mixture of salts provided, and thus form a liquid reaction medium, then to induce an at least partial, more preferably total, oxidation of the organic components of the waste provided; and
Recovering at least one compound resulting from the oxidation of said organic compounds;
   said at least one alkali metal hydroxide, preferably each alkali metal hydroxide, comprising water of crystallisation, acting as oxidising agent for the organic compounds in the reaction medium, so as to induce a production of dihydrogen, the latter being recovered, as a compound resulting from the oxidation, for the reuse thereof.

The method according to the present invention allows for a reuse of waste comprising organic components, in particular via the recovery of dihydrogen able to be used downstream of the method as combustible gas or chemical feedstock. Furthermore, as the oxidation of the organic components of said waste is carried out in a liquid medium, the method according to the invention makes it possible to limit the discharge of harmful compounds and consequently to reduce the impact of said method on the environment.

Optionally, the invention can further have at least any of the following features. The waste provided to the reactor can further comprise metal components, the reactor being heated at a temperature less than the boiling temperature of said metal components. Preferably, the reactor is heated to a temperature lower than the melting temperature of at least one portion of said metal components. Said method can further comprise a step of recovering by filtration metal components of the reaction medium. The method according to this features constitutes a preferred embodiment of the invention. The salt or mixture of salts according to the features mentioned hereinabove is not corrosive for metals, i.e. no notable oxidation reactions of the metal components occurs during the duration of the treatment of the waste. The method according to this feature therefore allows for a later reuse of these metals. Furthermore, as the heating temperature can be lower than the melting temperature of at least one portion of the metal components, a melting of the at least one portion of said components is prevented. The metal components can remain in the solid state and can therefore be physically separated from the reaction medium at the heating temperature of the reactor.

The reactor can be heated in such a way as to prevent a pyrolysis of the organic components of said waste. Preferably, the reactor can be heating at a temperature lower than the pyrolysis temperature of the organic components. More preferably, the reactor can be heated at a temperature less than the boiling temperature of at least one portion of the organic components. Thus, the temperature of the reaction medium can be limited between the melting temperature of the salt and the boiling temperature of said components. The at least partial, preferably total, oxidation reaction of the organic components can consequently be carried out in a liquid medium. This has several advantages. Firstly, the oxidation of the organic matter in the liquid medium induces the production of carbonates which are trapped in the molten salt. The method such as described consequently allows for a substantial reduction in the emissions of carbon dioxide and prevents the emission of dioxin. Secondly, the halogenated compounds are also trapped in the molten salt. The method therefore prevents the emission of halogenhydric acids such as hydrochloric, hydrofluoric or hydrobromic acid, with brominated compounds often being used as flame retardants, such as polybromodiphenylethers (PBDE), hexabromocyclododecane (HBCDD), tetrabromobisphenol A (TBBPA), and polybromobiphenyls (PBB).

Among the implementation elements of the method, at least the reactor can be at atmospheric pressure. The molten salt such as described having low vapour pressure and the oxidation reaction being carried out in a liquid medium, the method can indeed be carried out at atmospheric pressure.

Said at least one alkali metal hydroxide, preferably each alkali metal hydroxide or the mixture of such hydroxides, can form a compound with a low melting point. For example, said at least one alkali metal hydroxide, preferably each alkali metal hydroxide or the mixture of such hydroxides, can form a compound of which the melting temperature is comprised between 50° C. and 300° C. Using a compound with a low melting point makes it possible to limit the energy required for the formation of the reaction medium. Consequently, the energy cost of the method is minimised. Said at least one alkali metal hydroxide, preferably each alkali metal hydroxide or the mixture of such hydroxides, can be a defined or undefined compound. Furthermore, said at least one alkali metal hydroxide, preferably each alkali metal hydroxide or the mixture of such hydroxides, can form a eutectic with the water of crystallisation. Using a eutectic between said at least one alkali metal hydroxide and the water allows for a decrease in the melting temperature of the salt or of the mixture of salts.

According to a particular embodiment, said at least one alkali metal hydroxide is potassium hydroxide. More particularly, potassium hydroxide forms a eutectic with a monohydrate portion, of formula KOH+KOH.H₂O (1:1). Thus, the melting temperature of the eutectic of formula KOH+KOH.H₂O is substantially equal to 100° C.

The step of heating of the method according to the invention can be configured in such a way that the temperature of the reaction medium is comprised between 100° C. and 450° C., preferably 170° C. and 350° C., even more preferably between 170° C. and 250° C.

According to a particular embodiment, the waste can include Automobile Shredder Residues. Preferably, the waste can be constituted of Automobile Shredder Residues.

According to a particular embodiment, the waste can include Solid Recovered Fuel. Preferably, the waste can be constituted of Solid Recovered Fuel.

Among the implementation elements of the method, at least the reactor can be maintained in an atmosphere comprising an inert treatment gas, such as argon or nitrogen. Preferably the treatment gas is nitrogen. Thus a reaction of the dihydrogen produced in the gaseous phase with said atmosphere is limited, even suppressed, which minimises the risk of explosion.

Among the implementation elements of the method, at least the reactor can be made from a material resistant to said liquid reaction medium. Preferably, the reactor is made of stainless steel, for example chosen from the range of carbon steels, stainless steels of the type 304 and 316, or with a cobalt alloy base, such as stellite, or a nickel alloy base, such as Inconels® and Hastelloy®. Indeed, using a reaction medium that is little, or even not corrosive at all for the metals as well as reducing emissions of halogenhydric acids advantageously makes it possible to use stainless steel to form at least some of the implementation elements of the method. In particular, the reactor can be made from stainless steel without there being any notable corrosion of the walls of the reactor over the duration of the treatment of the waste.

According to a particular embodiment, the method is exempt from a step of adding, in the reactor, an oxidising agent other than water. The water of crystallisation acting as oxidising agent for the organic compounds, it is then not necessary to add to the reactor another oxidising agent, such as dioxygen. As the adding of dioxygen is avoided, the risk of explosion linked to the presence of dioxygen, in addition to the dihydrogen produced, is minimised. Furthermore, the presence of water of crystallisation makes it possible to limit the adding of water in the method, thus reducing the consumption of water, as well as the volume of effluents to be treated downstream of the method. Preferably, the method is exempt from a step of adding in the reactor, an oxidising agent other than the water of crystallisation initially comprised in the alkali metal hydroxide.

The step of recovering said at least one compound resulting from the oxidation of said organic compounds can furthermore include the recovery of a gaseous fraction comprising the dihydrogen produced. Said gaseous fraction can comprise a plurality of non-harmful gases such as methane, nitrogen as well as volatile organic compounds in addition to the dihydrogen produced. These gases can furthermore be separated by techniques known to those skilled in the art, optionally for the reuse thereof.

The method can further comprise a step of adding at least one catalyst chosen from hydrogenation catalysts. Adding a hydrogenation catalyst to the reaction medium makes it possible to increase the redox reaction kinetics by heterogeneous catalysis as well as the quantity of dihydrogen produced. Said at least one catalyst can comprise metal particles, for example with a nickel or iron base, or a mixture of such particles.

### BRIEF DESCRIPTION OF THE FIGURES

The purposes and objects as well as the features and advantages of the invention shall appear better in the detailed description of an embodiment of the latter that is illustrated by the following accompanying drawings.

FIG. 1 shows the steps of the method for reusing waste comprising organic components in a bath of molten salt(s) according to an embodiment of the invention.

FIG. 2 shows the steps of the method for reusing waste comprising organic components in a bath of molten salt(s) according to another embodiment of the invention.

The drawings are given as examples and do not limit the invention. They constitute schematic representations intended for facilitating the understanding of the invention.

### DETAILED DESCRIPTION

Before beginning a detailed review of embodiments of the invention, general aspects of the method are mentioned hereinafter as well as optional features, possibly used in combination or alternatively.

The method for reusing waste according to the present invention relates to all types of waste comprising organic components. More particularly, the method relates to the reuse of heterogenous waste, i.e. comprising organic components, potentially of diverse natures, even furthermore mixed with metal components. For example, said waste can be waste from electrical and electronic equipment; automobile shredder residues, in particular resulting from the shredding of end-of-life vehicles (ASR); or solid recovered fuel resulting from household waste (SRF).

Said method can further relate to the reuse of waste sorted homogeneously in such a way as to comprise organic components of a similar nature. For example, such waste results from materials such as polyethylene terephthalate or polyethylene glycol or resulting from polyester textiles. According to another example, this waste can furthermore be or include oils, for example used oil coming from vehicles.

Said method was furthermore tested with used organic molecules such as synthesised or purchased, such as sodium oxalate, ethylene glycol or cellulose. As molten salts are ionic mediums, molecules that have polar bonds are generally soluble and easily oxidisable at the temperatures described in what follows.

In the case where the waste is of a solid nature, said waste is generally shaped by a mechanical action, for example by chipping, shredding or crushing, upstream of the method, in particular during the recovery thereof at sorting facilities. In the case where said shaping is not carried out upstream of the method, the method for reusing according to the present invention can comprise a step allowing for the shaping of said waste before providing it 2 to the reactor. The waste thus shredded has an accessible surface that is more substantial for the oxidation of the organic components thereof in the molten salt bath. Where applicable, said method can comprise this step of shaping in addition to a shaping carried out upstream of the method, so as to increase the accessible surface of said waste. For example, the mechanical shaping of the waste leads to pieces with a size less than 5 mm.

According to the features mentioned hereinabove, the waste that the method relates to is in solid, even liquid, form. Waste in gaseous form is not however to be excluded, said waste able to be provided 2 to the reaction medium via bubbling.

In order to allow for the oxidation of the organic components of said waste, the method according to the present invention comprises the use of a salt or mixture of salts of which at least one salt, preferably each salt, comprises at least one alkali metal hydroxide or a mixture of such hydroxides. Said at least one alkali metal hydroxide, preferably each alkali metal hydroxide, comprises water of crystallisation, acting as oxidising agent for the organic compounds in the reaction medium. The water of crystallisation can furthermore make it possible to lower the melting point of the salt or mixture of salts.

It is specified that generally and in the framework of the present invention, the term “water of crystallisation” designates the molecules of water that are in the crystalline structure of the salt.

Generally and in the framework of the present invention, the term “oxidising agent” means a compound receiving at least one electron of another chemical species during a redox reaction.

Comprised in the crystalline structure of the salt, the water of crystallisation is stabilised by electrostatic interactions. Thus, the evaporation thereof is limited during the step of heating of the reactor and more particularly during the melting of said salt or mixture of salts provided for the formation of the liquid reaction medium. The water of crystallisation thus allows for an oxidation in liquid phase of the organic components, in particular by avoiding the additional adding of an oxidising agent.

Furthermore, the water of crystallisation induces a production of dihydrogen, an advantage that shall appear more clearly when reading examples presented hereinafter. More particularly, the dihydrogen produced is at least partially, even mostly, even totally, resulting from reduction of the water of crystallisation by the waste.

At least one salt, preferably each salt, comprises at least one alkali metal hydroxide or a mixture of such hydroxides. Indeed, it can be advantageous to use different alkali metal hydroxides according to the type of waste to be reused, in such a way for example to adapt the cost of the method. Furthermore, it is thus possible to vary interaction properties of said hydroxides with the organic components, even the organic and metal components, as well as with the compound(s) resulting from the oxidation of said organic components.

At least one alkali metal hydroxide, preferably each alkali metal hydroxide, comprises water of crystallisation. For example, the hydroxide is sodium hydroxide in the form of a eutectic or of a defined phase, or preferably potassium hydroxide.

At least one alkali metal hydroxide preferably forms a eutectic with the water of crystallisation. Thus, using a eutectic induces a melting temperature of the salt that is lower than that of a pure alkali metal hydroxide, which makes it possible to limit the heating temperature of the reactor. Consequently, a lower energy impact of the method is obtained.

By way of examples, the main defined phases of the alkali hydroxides with the water of crystallisation are given in the table hereinbelow, summarising the main compounds defined with the alkali metal hydroxides (P. Pascal, Nouveau traité de chimie minérale, Masson and Cie, Volume II (1 and 2), Paris, 1963; F.-Z. Roki, M.-N. Ohnet, S. Fillet, C. Chatillon, I. Nuta, J. Chem. Thermodynamics, 80, 2015, 147-160).

TABLE 1

| Congruent | y = 1 | | | | | | | y = 3 |
|---|---|---|---|---|---|---|---|---|
| T_{f} (° C.) | x = 1 | x = 2 | x = 3 | x = 3.5 | x = 4 | x = 5 | x = 7 | x = 1 |
| yLiOH—xH2O | | | | | | | | |
| yNaOH—xH2O | 65.1 | T_{f} | | 15.9 | T_{f} | T_{f} | T_{f} | |
| | | non | | | non | non | non | |
| | | congr. | | | congr. | congr. | congr. | |
| yKOH—xH2O | 145 | 33 | | | ~−34 | | | |
| yRbOH—xH2O | 145 | T_{f} | T_{f} | | T_{f} | | | T_{f} |
| | | non | non | | non | | | non |
| | | congr. | congr. | | congr. | | | congr. |
| yCsOH—xH2O | 226 | mix. | −5.5 | | | | | |
| | | phases | | | | | | |

By way of examples, the following table gives the main eutectics of alkali metal hydroxides with the water of crystallisation, and the melting temperature thereof. The phases are however not always identified, as indicated by the symbol (?).

TABLE 2

| MOH—H₂O | T_{f} (° C.) |
|---|---|
| CsOH—H₂O | 150 |
| 2CsOH•H₂O (?) | |
| KOH + KOH•H₂O | 100 |
| NaOH + NaOH•H₂O | 62 |
| RbOH—H₂O | 104 |
| 2RbOH•H₂O (?) | |

A mixture of alkali metal hydroxides comprised in said at least one salt can furthermore form a eutectic. The binary phase diagrams for the anhydrous alkali metal hydroxides were established, but there are no ternary diagrams of alkali metal hydroxides with the water, in particular due to the number of possible phases according to the molar fraction of water and the sharing of the molecules of water according to the alkali metal of the mixture. There are however compounds in an aqueous medium with defined phases such as, for example, NaOH—LiOH—H2O (A. Lach, L. Andre, A. Lassin, M. Azaroual, J.-P. Serin, P. Cézac, J. Solution Chem., 44, 2015, 1424-1451). The following table gives the melting temperature of eutectics for the binary systems of anhydrous hydroxides that can be used as molten salts with water.

TABLE 3

| binary compounds | T_{f}(° C.) |
|---|---|
| CsOH—KOH | ~192 |
| CsOH—LiOH | ~276 |
| CsOH—NaOH | ~152 |
| CsOH—RbOH | — |
| KOH—μLiOH | 255 |
| KOH—NaOH | 170 |
| KOH—RbOH | — |
| LiOH—NaOH | ~215 |
| LiOH—RbOH | 238 |
| NaOH—RbOH | ~155 |

Measurements of transience of the water in melted mediums taken between 140° C. and 200° C. with alkali hydroxides MOH (M=K, Na, Rb or Cs) have shown that potassium hydroxide is the hydroxide that best retains the water while sodium hydroxide releases it the most easily (W. M. Vogel, K. J. Routsis, V. J. Kehrer, D. A. Landsman, J. G. Tschinkel, Journal of Chemical and Engineering Data, 12(4), 1967, 465-472). Moreover, it is known that monohydrate lithium hydroxide, melted at 500° C. for one day, can further retain 0.05 mole of H₂O per mole of LiOH (P. Pascal, Nouveau traite de chimie minerale, Masson and Cie, Volume II (fascicule 1), Paris, 1963).

Considering an economic base, as well as its capacity to retain the water of crystallisation, sodium hydroxide is chosen preferably to form at least partially the bath of molten salt(s) in the method according to the invention.

More preferably, the salt therefore comprises potassium hydroxide having formula KOH+KOH.H₂O, having a melting point at 100° C. (P. Pascal, Nouveau traite de chimie minerale, Masson and Cie, Volume II (fascicule 2), Paris, 1963). Using a mixture of sodium hydroxide and potassium hydroxide can also be provided. For example, the mixture of sodium hydroxide and potassium hydroxide is of the formula NaOH—(KOH+KOH.H2O).

Experiments with the mixtures NaOH—(KOH+KOH.H2O) for different molar ratios between the sodium hydroxide and potassium hydroxide were conducted. Non-perfectly defined phases of the mixture NaOH—(KOH+KOH.H2O) were furthermore used. In any case, the water of crystallisation of the potassium hydroxide generated the oxidation of the organic materials.

Moreover, using compounds comprising at least one alkali metal hydroxide M can be provided, having formula MOH—H2O—X where X can for example be an alcohol (methanol, ethanol) or ammonia, for which the alcohol or the water constitute the solvent. X can also be an alkali metal salt or a transition metal.

The global oxidation reaction of the organic components unfolds according to a molten salt oxidation mechanism. This reaction comprises a solution treatment of the organic components by solvolysis. Solvolysis, generally and in the framework of the present invention, corresponds to a reaction between the organic components and a chemical species comprised in the reaction medium in such a way as to dissolve all or a portion of said components. Solvolysis is followed by an oxidation, in homogenous liquid phase, of the products resulting from the solvolysis of the organic components by the water of crystallisation. Solvolysis and oxidation reactions can however take place simultaneously. Furthermore, the total or partial dissolution of the organic components can result directly from the oxidation of said components.

The oxidation of the organic components of the waste induces in particular the production of carbonates by preventing the emission of dioxins. These carbonates remain dissolved in the reaction medium, reducing, and even preventing the emission of carbon oxides, and in particular carbon monoxide or dioxide. Indeed, no emission of carbon dioxide greater than 20 ppm was measured in the gaseous fraction resulting from the reaction medium, 20 ppm being the detection limit of the device used to take the measurement. Furthermore, any halogenated part resulting from the waste is transformed into halide ions. The halide ions are trapped in the reaction medium by electrostatic interactions, thus limiting the emission of halogenhydric acids such as hydrochloric, hydrobromic or hydrofluoric acid. According to the residence time in the bath, and considering the low boiling temperatures of these halogenhydric acids, a scrubbing of the hot gases can however be implemented at the outlet of the reactor in order to prevent any emission of traces of halogenhydric acids.

The oxidation of the organic components of the waste also induces the production of dihydrogen. The role of the water of crystallisation as oxidising agent for the production of hydrogen was revealed by the implementation of the method according to the invention with sodium oxalate as waste to be reused. The sodium oxalate is an organic molecule that does not have any hydrogen atom. During the oxidation of this molecule according to the method, a production of hydrogen is observed in the reactor. The quantity of dihydrogen produced corresponds to the number of moles required for the oxidation of the sodium oxalate. The dihydrogen therefore comes from a species playing the role of oxidising agent of the sodium oxalate and including hydrogen atoms, which water of crystallisation designates.

Likewise, the implementation of the method according to the invention with polyethylene terephthalate bottles as waste to be reused induces a production of dihydrogen, the quantity of which is greater than the number of moles of hydrogen contained in the monomers of the polyethylene terephthalate. In this case, the dihydrogen produced comes jointly from the organic material and from the reduction in water of crystallisation. This conclusion has also been validated using powdered cellulose.

According to a particular embodiment, hydrogenation catalysts are added to the liquid reaction medium. Adding these catalysts relocates the oxidation of the organic components on the surface of the catalysts rather than in homogeneous liquid phase. The oxidation reaction is then produced by heterogeneous catalysis, requiring in fact less contact between the molecules of water and the organic components. The reduction reaction kinetics of the water of crystallisation, and consequently the quantity of dihydrogen produced, are thus increased. The hydrogenation catalysts comprise metal particles, preferably with a nickel or iron base, even a mixture of such particles.

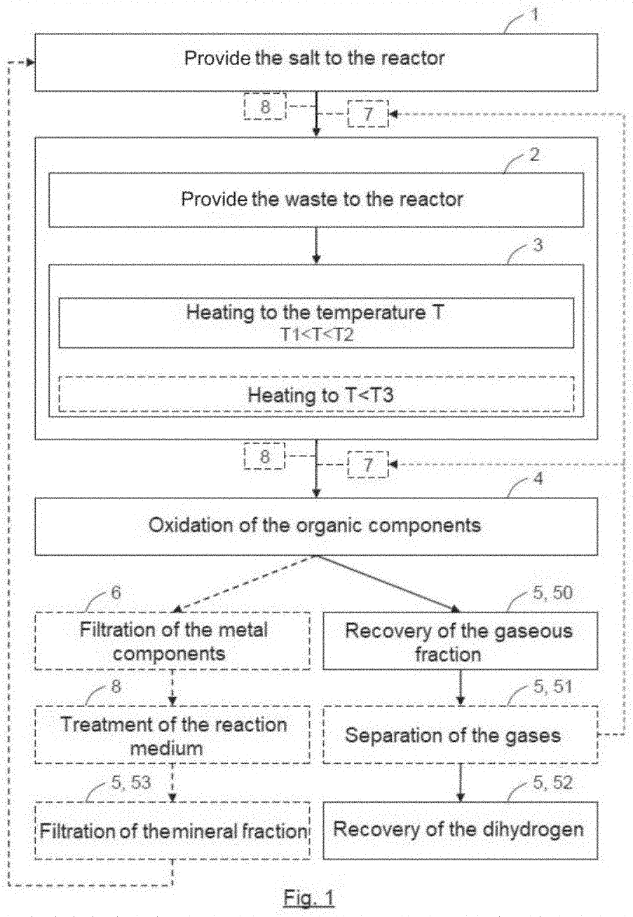

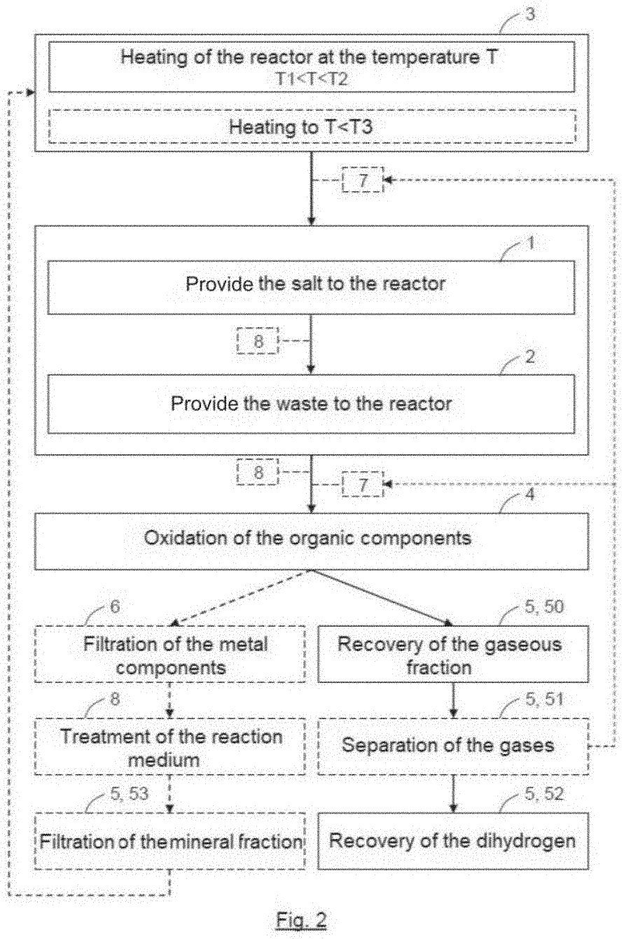

By way of example, the method is shown in FIGS. 1 and 2, where alternatives of the method are indicated by paths in parallel and optional steps are indicated in dotted lines. As shown in FIG. 1, the method comprises a step during which at least one salt or a mixture of salts, according to the features described hereinabove, are provided 1 to a reactor; a step during which the waste is provided 2 to the reactor; and a step of heating 3 the reactor at a temperature T higher than the melting temperature T1 of the salt or mixture of salts. Preferably, the temperature T is comprised between the temperature T1 and the temperature T2, the temperature T2 being chosen from the pyrolysis temperature of the organic components of the waste, and, preferably, the boiling temperature of at least one portion of these components. In the case where the waste comprises metal components, the temperature T is furthermore lower than the boiling temperature, and, preferably the melting temperature of the metal components. According to a particular embodiment, the temperature of the reaction medium is comprised between 100° C. and 450° C., preferably between 170° C. and 350° C. It is indeed advantageous to work at a temperature higher than 100° C., so as on the one hand to provide thermal energy to the oxidation reaction. On the other hand, a low viscosity of the molten salt can be obtained, in order to favour better wetting of the surface of the waste by the solution of molten salt(s) as well as an effective brassage of the reaction medium. According to a particular embodiment, the temperature of the reaction medium is comprised between 170° C. and 250° C., in particular when the organic components can be oxidised at low temperature by the water of crystallisation.

Via the three steps described hereinabove, a liquid reaction medium is obtained, comprising the salt or mixture of molten salts as well as the waste, in such a way as to induce the global oxidation reaction 4 of the organic components of the waste. The relative order of these three steps can be modified according to the embodiments of the method. In particular, as shown in FIG. 1, the salt or mixture of salts and the waste can be introduced 1, 2 into the reactor, successively or as a mixture. The reactor can then be heated 3 at the temperature T. Alternatively, a mixture comprising the salt or mixture of salts and the waste can be introduced 1, all at once or preferably progressively, into the reactor heated 3 beforehand at the temperature T. This alternative is shown in FIG. 2. Thus, a progressive melting of the salts can allow for solvolysis and the oxidation reaction of the waste by preventing the pyrolysis thereof. Progressively adding this mixture furthermore makes it possible to prevent a drop in the temperature of the reaction medium. The salts can further be melted and the waste heated before the introduction thereof into the reactor. Thus, the method according to this particular embodiment makes it possible to prevent a period of latency caused by the rise in temperature inside the reactor during the heating 3 thereof. This embodiment also allows for an implementation of the method continuously, according to which the salt or mixture of salts and the waste, are continuously introduced into the reactor, while also allowing for a continuous emptying of the reactor.

As shown in FIGS. 1 and 2, catalysts can furthermore be added 8 to the reactor, during or following the introduction 1 of the salt or of the mixture of salts. Preferably, the catalysts are mixed with the salt. It can also be provided that the adding 8 of catalysts be carried out later, for example, the catalysts can be introduced once the liquid reaction medium is formed.

The global oxidation reaction 4 of the organic components takes place, in the manner described hereinabove. During this oxidation 4, the reactor is maintained at the temperature T, even the temperature T is modulated, while still remaining within the interval comprised between T1 and T2, even between T1 and T3, T3 being the boiling temperature of at least one portion of the metal components able to be mixed with the organic components. Preferably, T3 is the melting temperature of most of the metal components that can be mixed with the organic components. In particular, it is possible to increase the temperature T in such a way as to provide thermal energy in order to accelerate the oxidation reaction of the organic components. Furthermore, a mixture of the reaction medium is advantageously carried out in such a way as to facilitate the reaction.

The reactor for the implementation of the method according to the invention can be a reactor with a heating mode via conduction (heating via resistors for example), by convection (for example via a flow of hot gases circulating in the reactor) or via luminescent or electromagnetic radiation (induction, microwaves). According to the volume or the mass of organic waste to be treated in solid, liquid or gaseous phases, the nature of the oven comprising the materials required for the construction thereof will be different; the method of heating can also be adapted according to the techniques known to those skilled in the art. The mode of heating moreover induces a choice for the stirring mode of the mass in fusion in the reactor. For example, in order to ensure the mixing of the reaction medium, the reactor heated by resistors comprises at least one element able to mix said medium, such as a rotating wall, a rotor or a blade.

As the reaction medium according to the invention is not by nature corrosive for metals in the range of heating temperature 3, and as the emissions of halogenhydric acids are avoided, the reactor can be made of metal, preferably of stainless steel, without there being any notable corrosion of the walls of the reactor during the implementation of the method. It can also be provided that the reactor have a cobalt alloy base, such as stellite, or a nickel alloy, such as Inconels® and Hastelloy®. Note that other materials that do not belong to the category of metals can also be used, such as carbon or boron nitride. Indeed, in the absence of dioxygen and of carbon dioxide, carbon graphite or glass carbon for example would not be oxidised by the water up to heating temperatures of 450° C.

During the oxidation reaction 4 of the organic components, two or even three fractions are obtained: a liquid fraction comprising the reaction medium and oxidation products 4 such as carbonates; a gaseous fraction comprising a plurality of gases resulting from the oxidation 4 of the organic components, and more particularly dihydrogen; a solid fraction, for example in the case where the waste includes metal components.

As shown in FIGS. 1 and 2, the method according to the invention comprises a step of recovering 5 at least one compound resulting from the oxidation 4 of the organic components. The method more particularly comprises the recovery 50 of the gaseous fraction given off from the reaction medium. The gas or gases resulting from the oxidation can carried away by a carrier gas. Preferably, the reactor is supplied 7 with a continuous flow of a carrier gas to carry the gas or gases resulting from the oxidation 4. The reactor is thus supplied by a carrier gas between any of the steps of the method upstream of the oxidation 4 of the organic components. More preferably, the carrier gas is a neutral gas, such as argon or nitrogen, in order to prevent any risk of explosion with the dihydrogen produced. Preferably, the carrier gas is nitrogen so as to limit the cost of the method.

Furthermore, the measurements taken by thermogravimetric thermo-differential analyses (designated by the abbreviation TGA-TDA) show that the water of crystallisation contained in the potassium hydroxide can be at least in part released above 300° C. To overcome the exiting of the water of crystallisation required for the oxidation reaction, the carrier gas can be hydrated, in particular for the high heating temperatures 3 of the reactor, for example for the range of temperatures comprised between 350 and 450° C. Thus, a water balance in the form of vapour is maintained between the liquid reaction medium and the gas phase above the liquid. Although it does not seem that this hydration of the carrier gas has any importance up to 350° C. (temperature zone corresponding to molecules that are easily oxidised), an increase appears in the production of gas resulting from the oxidation at temperatures higher than 350° C.

The gaseous fraction recovered 50 is comprised of a plurality of gases such as dihydrogen, methane and nitrogen, as well as volatile organic compounds. These different components can be separated 51 by techniques known to those skilled in the art. For example, volatile organic compound are condensed by lowering the temperature of the gaseous fraction below 80° C. The purpose is to separate the gases in order to reuse them. In particular, the dihydrogen is recovered 52 to be reused as a combustible fuel or as a chemical feedstock. Methane can be recovered to be reused as a combustible gas. Furthermore, nitrogen can be recovered to be used as a carrier gas intended for supplying 7 the reactor.

The solid fraction comprising the metal components of waste can be recovered via filtration 6. The filtration is carried out from the reaction medium using at least one grid, preferably a stainless steel grid having a dimension for the filtration less than the size of the metal components, for example substantially equal to 0.8 mm. This filtration step 6 can be carried out when the reaction medium is at the heating temperature 3 of the reactor, and in particular in the case where at least one portion of the metal components has a melting temperature higher than the heating temperature 3 of the reactor. Moreover, this step of filtration 6 can be carried out at a temperature comprised between the melting temperature of the salt or of the mixture of salt(s), and the melting temperature of all the metal components that the waste can comprise. For example, this temperature can correspond to the heating temperature 3 of the reactor or be reached following a cooling of the reaction medium. The reaction medium can further be cooled to a temperature lower than the melting temperature of the salt or of the mixture of salt(s). The reaction medium, right from the solid phase, can be dissolved in a volume of water before proceeding with filtration 6 using at least one grid. According to this example, the grid can be of dimensions less than those used when the salt or mixture of salt(s) is melted.

The liquid fraction comprising the reaction medium and oxidation products 4 such as carbonates can be treated 8 in such a way as to regenerate the salt or mixture of salts for the reuse thereof in the method. For example, the reaction medium dissolved in a volume of water, is treated 8 with quick or slaked lime having formula Ca(OH)₂, preferably at room temperature. Adding lime induces a cold precipitation of calcium carbonate and produces samples of CaCO₃ such as calcite, even a mixture of calcite and aragonite, that can be used in concrete.

The treatment 8 can furthermore provide hydroxyl ions for the regeneration of the alkali metal hydroxides. The salt or mixtures of salts can thus be reused in the method.

The implementation of the method relating to the management or the recovery of gaseous, liquid and solid fractions makes use of unitary operations such as mixers, filtrations of which the implementation elements exist in the market.

The method can be carried out discontinuously by using a conventional reactor of the “batch” type, i.e. including a cell. The salt or mixture of salts as well as the waste are introduced into the cell. The waste thus introduced is reused according to the steps of the method. New waste, even a new batch of salt or mixture of salts, is introduced into the cell for the reuse thereof. The method is therefore discontinuous and sequentially treats different batches of waste. Alternatively, the method can moreover be carried out continuously by using a reactor including at least one inlet and one outlet configured in such a way that the supply of waste, even the recovery of at least one compound resulting from the oxidation of the organic components, for example dihydrogen, is carried out continuously. For this, a reactor comprising an endless screw is considered, while still taking account of the explosivity of the gases produced.

The invention is not limited to the embodiments described hereinabove and extends to all the embodiments covered by the claims.

In particular, it can be provided that the method be carried out over a range of pressures ranging from atmospheric pressure to higher pressures. As the salt or mixtures of molten salts have a low vapour pressure and the oxidation reaction is carried out in a liquid medium, the method can indeed be carried out at atmospheric pressure. The maximum pressure is chosen for safety aspects and therefore depends on the reactor and implementation elements of the method. Preferably, the method could be carried out at a pressure less than 8 bar.

1. A method for reusing waste comprising organic components in a bath of molten salt(s) comprising the following steps:
Providing to a reactor, at least one salt or a mixture of salts having a melting temperature and of which at least one salt comprises at least one alkali metal hydroxide or a mixture of such hydroxides;
providing said waste to the reactor;
Heating the at least one salt or mixture of salts in the reactor to a temperature above the melting point of said salt or mixture of salts to:
melt said provided salt or mixture of salt, and thus form a liquid reaction medium; then to
induce an at least partial oxidation of the organic components of the provided waste; and
Recovering at least one compound resulting from the oxidation of said organic compounds;
said at least one alkali metal hydroxide comprising water of crystallisation, acting as oxidising agent for the organic compounds in the reaction medium, so as to induce a production of dihydrogen, said dihydrogen being recovered, as a compound resulting from the oxidation, for the reuse thereof.

2. The method according to claim 1, wherein said waste provided to the reactor further comprises metal components, the at least one salt or mixture of salts in the reactor being heated to a temperature less than the boiling temperature of said metal components, said method further comprising a step of recovering by filtration metal components of the reaction medium.

3. The method according to claim 1, wherein the at least one salt or mixture of salts in the reactor is heated in such a way as to prevent a pyrolysis of the organic components of said waste.

4. The method according to claim 1, wherein said at least one alkali metal hydroxide or the mixture of such hydroxides, forms a compound with a low melting point, and wherein said compound can be a eutectic.

5. The method according to claim 1, wherein said at least one alkali metal hydroxide is potassium hydroxide.

6. The method according to claim 5, wherein the potassium hydroxide forms with the water of crystallisation, a eutectic having formula KOH+KOH.H2O.

7. The method according to claim 1, wherein the step of heating is configured in such a way that the temperature of the reaction medium is comprised between 100° C. and 450° C.

8. The method according to claim 1, wherein the waste includes Automobile Shredder Residues.

9. The method according to claim 1, wherein the waste comprises Solid Recovered Fuel.

10. The method according to claim 1, wherein the reactor is maintained in an atmosphere comprising an inert treatment gas.

11. The method according to claim 1, wherein the reactor is made from a material that resists said liquid reaction medium.

12. The method according to claim 1, said method being exempt from a step of adding in the reactor, an oxidising agent other than water.

13. The method according to claim 1, wherein the step of recovering said at least one compound resulting from the oxidation of said organic compounds comprises the recovery of a gaseous fraction comprising the dihydrogen produced.

14. The method according to claim 1, further comprising a step of adding to the reaction medium at least one catalyst chosen from hydrogenation catalysts.

15. The method according to claim 14 wherein said at least one catalyst comprises metal particles with a nickel or iron base or a mixture of such particles.
